(19) United States
(12) Patent Application Publication
(10) Pub. No.: US 2017/0129156 A1
(43) Pub. Date: May 11, 2017

(54) Extruder Including a Threaded Barrel

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Arnaud LETOCART, Clermont-Ferrand (FR); Bernard CAPPA, Clermont-Ferrand (FR); Christophe OUGIER, Clermont-Ferrand (FR); Philippe LAMOINE, Clermont-Ferrand (FR); Gérard CROSSNIER, Ceyrat (FR); Josian GOURDOUZE, Le Combaou (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/322,648

(22) PCT Filed: Jun. 30, 2015
(86) PCT No.: PCT/EP2015/064901

§ 371 Date: Dec. 28, 2016

(30) Foreign Application Priority Data
Jun. 30, 2014 (FR) 1456184

(51) Int. Cl. B29C 47/66; B29C 47/60; B29C 47/62

(52) U.S. Cl. CPC B29C 47/668; B29C 47/627; B29C 47/6025; B29C 47/6087; B29K 2105/0067

(57) ABSTRACT

An Extruder for providing a flow of viscoelastic material such as rubber is disclosed herein. The extruder includes several zones (A, P, H, S), each assigned to a particular rheological function and arranged axially from an upstream end to a downstream end of the extruder and having an endless screw of given diameter (D). In each of the zones, at least one helicoidal flight extends radially from a central shaft of the screw over a height (h₁), in a direction and with a pitch which are defined for each of the zones, and which is rotationally driven about an axis (XX′) in a barrel. The barrel is provided with various structures to further assist with the flow of the viscoelastic material

### CROSS-REFERENCE TO RELATED APPLICATION

This application is a 371 national phase entry of PCT/EP2015/064901, filed 30 Jun. 2015, which claims the benefit of French Patent Application No. 1456184 filed 30 Jun. 2014, the contents of which are incorporated herein by reference for all purposes.

### BACKGROUND

The disclosure relates to the field of the extrusion of viscous plastic materials, and more particularly of viscoelastic materials such as rubber.

Traditionally, these materials are shaped using an extrusion means that comprises a threaded screw rotated in a cylindrical barrel and opening onto profiling means.

In order to improve the characteristics of the products obtained, numerous adaptations have been made to the design of extruders and more particularly of extruder screws. Thus, in the known way, there is a feed zone, intended to receive the materials in a solid or low-viscosity state, then a working or plasticising zone in which the pressure and temperature of the material are raised in order to be able to transfer it in the downstream direction of the device, a homogenisation zone in which the material is kneaded in order to ensure that its properties are suitably uniform, and a final part opening onto an extrusion die or into a shaping device such as a mould.

Most of the energy supplied to the material comes from the mechanical energy transmitted by the extrusion screw which is converted into thermal energy under the effect of the shearing that the material experiences as it passes between the flights of the screw and the plain barrel of the various working zones listed above.

With a view to improving the overall performance of the device, the extrusion throughput can be increased by increasing the speed at which the screw rotates. However, this solution remains limited because it contributes to increasing the amount of energy supplied to the material and therefore to increasing its temperature, which is something which may prove prejudicial to maintaining the material properties.

To these same ends, it is also possible to increase the pitch of the screw in order to make the material easier to transfer. However, this solution remains limited to the extrusion of materials of low or very low viscosity that do not require high transfer pressures or the input of a particularly great amount of work.

Hence, the route most commonly taken for processing more viscous materials at a high throughput is to increase the diameter of the screw and to reengineer the plant bigger, although this is not without an impact on the cost of the extrusion device.

Out of a concern for economy, it is also possible to seek to introduce the materials cold, which means to say at the ambient temperature of the workshop, in order to avoid the cost of a preliminary warming and plasticising step. The material introduced is then highly viscous and requires the input of a large amount of energy in order to be able to be extruded through a die.

### DESCRIPTION OF RELATED ART

Document U.S. Pat. No. 4,125,333 describes an extruder intended to work with molten resin. According to that document, the extruder performance is improved by making helicoidal channels in the barrel. These barrel channels rotate in the same direction as those of the screw and are intended to cause the molten resin to catch better on the metallic parts of the extruder.

Another example of an extruder for molten plastics material is described in document CN 103770310 in which the depth of the screw channels increases axially in the direction in which the material flows, whereas that of the cylinder channels decreases. This is intended to allow the extruder to work with solid and liquid material as the material gradually progresses along inside the extruder in order quickly to obtain molten plastics material at the exit of the extruder.

### SUMMARY

None of the extruders described in the Background are able to operate with raw rubber.

It is an object of the disclosure to propose an alternative solution that makes it possible to increase the throughput of the extruder intended to work with viscoelastic materials such as rubber while at the same time keeping control over the size of the device and the amount of power required.

The extruder according to the disclosure comprises several zones, each assigned to a particular rheological function and arranged axially from an upstream end to a downstream end of the extruder.

The extruder comprises an endless screw of given diameter, comprising, in each of the zones, at least one helicoidal flight extending radially from a central shaft of the screw over a height, in a direction and with a pitch which are defined for each of the zones, and which is rotationally driven about an axis in a barrel. The extruder is characterised in that the barrel comprises at least one helicoidal flight defining at least one helicoidal path via which some of the flow of material is intended to progress, and travelling through each of the said zones extending radially inwards over a height of the flight of the barrel which is comprised between 0.1 and 0.5 times the height of the flight of the screw and in which extruder the flight of the barrel forms a helix rotating in the opposite direction to the direction of the helix formed by the flight of the screw.

The presence of a barrel that is threaded over the entire length of the extruder makes it possible to increase the cross section for the passage of the material and increase the throughput. The helicoidal shape of the flight of the screw also makes it possible to contribute to its forward progress.

It has been found, during tests conducted in the laboratory, that for a barrel flight height comprised between 0.1 and 0.5 times the height of the flight of the screw, it is possible to achieve a significant increase in the throughput of the extruder and, at the same time, to optimise the work input to the mixture passing through the said helicoidal path. Specifically, it was found that, for barrel flight heights greater than 0.5 times the height of the flight of the screw, the mixture can no longer be forced along the helicoidal path as the screw rotates and that it remains blocked in stagnation zones notably in the bottom of the grooves of the flight of the barrel. It has also been found that a barrel flight of low height, less than 0.1 times the height of the flight of the screw, has practically no effect on increasing the throughput of the extruder or on the work input to the mixture.

Thus by also adjusting the pitch of the flight or flights of the barrel the throughput of material passing along the helicoidal path or paths delimited by the flight or flights of the barrel obtained is comprised between 10 and 50% of the total throughput of material passing through the extrusion device.

For preference, the height of the flight of the barrel is equal to 0.3 times the height of the flight of the screw and the pitch of the flight of the barrel is adjusted so that the proportion of the flow of material that passes along the said helicoidal path of the barrel is 30% of the total flow.

According to the disclosure also, the direction of rotation of the helix formed by the flights of the barrel is the reverse of the direction of rotation of the helix formed by the flights of the screw. The reversal of the direction of the flights of the barrel with respect to the direction of the flights of the screw thus allows additional mechanical work to be supplied to the material without the need to increase the rotational speed excessively.

Finally, by adapting, as will be seen later, the number, height, pitch and shape of the flights of the screw and of the barrel in each of the zones, the work input to the material is optimised while at the same time maintaining the expected throughput performance.

For preference, the width of the helicoidal path is greater than the width of the helicoidal flight of the barrel.

It was found during tests conducted in the laboratory that, in order to increase the throughput of a screw and barrel extruder, the screw and barrel of which are provided with flights along their entire length, one condition necessary for the correct displacement of the elastomeric material as it is being formed between the end at which it enters the barrel and the end at which it leaves the same, is that the width of the grooves of the threaded path be greater than the width of the helicoidal flight of the barrel. This condition needs advantageously to be met over the entire length of the barrel. This is because the shearing of the elastomeric material that is being formed between the flights of the screw and those of the barrel when they rotate in opposite directions is so great that the temperature of the material increases very greatly. Thus, in order to avoid an increase in temperature that might be accompanied by a risk of the material becoming degraded, it is necessary to increase the cross section for the passage of the material between the flights.

Such is not the case with the flights of the barrels of the prior art which are intended to block the rotation of the plastic or thermoplastic materials in the fluid or semifluid state. An elastomeric mixture cannot work with such extruders because there is the additional risk of it remaining blocked in the narrow grooves of the barrel.

Advantageously, the ratio between the width of the grooves of the helicoidal path and that of the helicoidal flight of the barrel is comprised between 3 and 10 and preferably between 5 and 10. These values have been optimised to ensure the correct level of shearing of the material necessary for the forming thereof and, at the same time, the displacement of the flow of material along inside the extruder.

The extruder according to the disclosure may also comprise the following features alone or in combination:
in each of the zones, the pitch of the flights of the barrel is greater than or equal to the pitch of the flights of the screw;
the height of the flight of the barrel and that of the flight of the screw are constant over the length of at least one zone;
the extruder comprises one or more zones each separately performing one of the following rheological functions: a feed zone, devoted to the introduction and plasticising of the material, a compression zone, devoted to increasing the temperature and pressure of the material, a homogenisation zone, devoted to homogenising the rheological properties of the material, a stabilisation zone, devoted to stabilising the flow of material before it leaves through an extrusion die;
in the feed zone, each flight of the screw comprises at least one cutout intended to encourage mechanical catching on the incoming material, and arranged in such a way that no cutout is axially aligned with a cutout located on the adjacent flights;
in the feed zone, the screw comprises at least four flights;
in the compression zone, the screw comprises a single flight;
in the compression zone, the screw has a pitch comprised between 0.5 and 1.5 times the diameter of the screw;
in the compression zone, the diameter of the shaft of the screw is less than the diameter of the shaft of the screw in the zone situated upstream or downstream of the said compression zone;
in the homogenisation zone, the screw comprises at least two flights;
in the homogenisation zone, the screw has a pitch comprised between 1 and 1.5 times the diameter of the screw;
in the homogenisation zone, the flights of the screw or of the barrel are interrupted in such a way as to form cylindrical annular spaces;
in the homogenisation zone, the shaft of the screw or the barrel comprises fingers extending radially and arranged in such a way as to run in the said cylindrical annular spaces;
in the stabilisation zone, the screw and the barrel each comprise two flights.

### BRIEF DESCRIPTION OF THE DRAWINGS

The disclosure will be better understood from studying the attached figures which are given by way of entirely non-limiting example and in which:

FIG. 1 depicts a schematic overview in cross section of an extruder according to the invention;

FIG. 2 depicts a more detailed view in cross section of the feed zone;

FIG. 3 depicts a more detailed view in cross section of the compression zone;

FIG. 4 depicts a more detailed view in cross section of the homogenisation zone;

FIG. 5 depicts a more detailed view in cross section of the barrel in the homogenisation zone;

FIG. 6 depicts a more detailed view in cross section of the stabilisation zone;

FIG. 7a depicts a view in cross section of the barrel in the feed zone and FIG. 7b is a view similar to that of FIG. 2a, but in which the screw and the mixture are also depicted.

### DETAILED DESCRIPTION

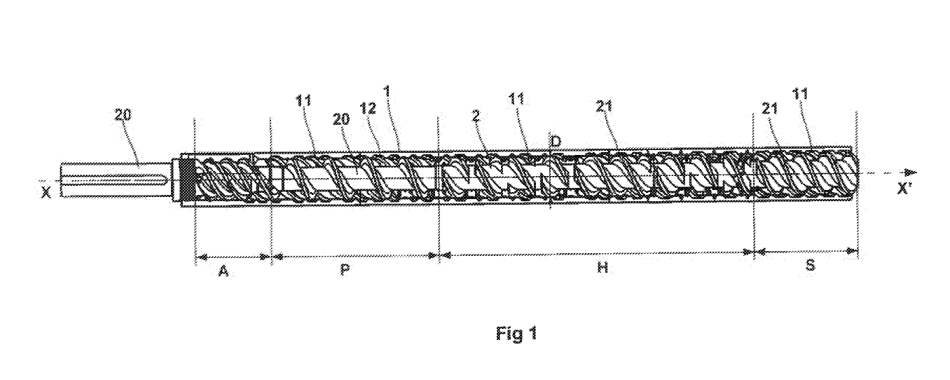

The extrusion device illustrated in FIG. 1 is intended for working with an elastomeric material (or rubber) and is formed of an endless cylindrical screw 2 rotationally driven by a geared motor assembly (not depicted) about an axis XX′ in a barrel 1. The screw and the barrel have substantially equal lengths. The extruder comprises a plurality of specific zones A, P, H and S arranged in succession one downstream of the next along the axis XX′ when considering that the material flows from upstream to downstream in the direction of the arrow borne by the axis XX′.

In each of the zones, the shaft 20 of the screw supports one or more helicoidal flights 21 extending radially outwards. The number of flights, the height and the shape and pitch of the flights of the screw may vary from one zone to another as will be seen later on. The flights of the screw form a helix, the direction of rotation of which is constant along the entire length of the screw. In the case of the screw illustrated in FIG. 1, the direction of rotation of the helix is the clockwise direction.

The barrel 1 supports one or more helicoidal flights 11 of which the height h₂, the shape and the pitch may also vary according to the zone considered. These flights extend over the entire length of the barrel from its upstream end to its downstream end.

The figures illustrate a barrel that is threaded over its entire length, comprising two flights having a pitch that is constant along the entire length of the barrel.

For preference according to the invention, the pitch of the helicoidal flights 11 of the barrel 1 is comprised between one and four times the diameter of the screw 2.

The free space of height h₂, situated between the base of the flight or flights 11 borne by the barrel 1 and delimited by the said flights, forms one or more helicoidal paths through which a proportion of the flow of material is made to circulate.

The direction of rotation of the helix formed by the flights of the barrel is the reverse of the direction of rotation of the helix formed by the flights of the screw. Also, in the case of the barrel used as the basis for the present description, the flights rotate in the anticlockwise direction. The fact that the direction of the flights of the barrel is the reverse of the direction of the flights of the screw thus allows additional mechanical work to be input to the material without the need to increase the rotational speed excessively.

The diameter D of the cylindrical screw 2 is defined by the overall value measured between the radial tips of the flights of the screw.

In order for the gains in throughput to be significant, the height h₂ of the flights of the barrel (see FIG. 3) needs to represent a significant percentage of the height h₁ of the flights of the screw. During tests conducted in the laboratory, it was found that a percentage of the order of at least 10% is a minimum threshold for obtaining the desired advantages, which are associated with the increase in throughput, combined with the possibility of processing viscous or even highly viscous materials while introducing them cold, and while at the same time achieving at the exit from the extruder a rheological state that is optimum for the shaping of a profiled strip through a die.

As a general rule, steps are taken to ensure that the throughput of material passing between the flight or flights 11 of the barrel 1 or, stated differently, along the helicoidal path or paths of height h₂ delimited by the flight or flights 11 of the barrel, is comprised between 10 and 50% of the total throughput of material passing through the extrusion device.

In order to achieve this performance and encourage the material to flow in the flights of the barrel, the pitch of the flights of the barrel will therefore be adjusted so that, in each of the zones, it is greater than or equal to the pitch of the flights of the screw.

The number of flights of the barrel may usefully be equal to 2.

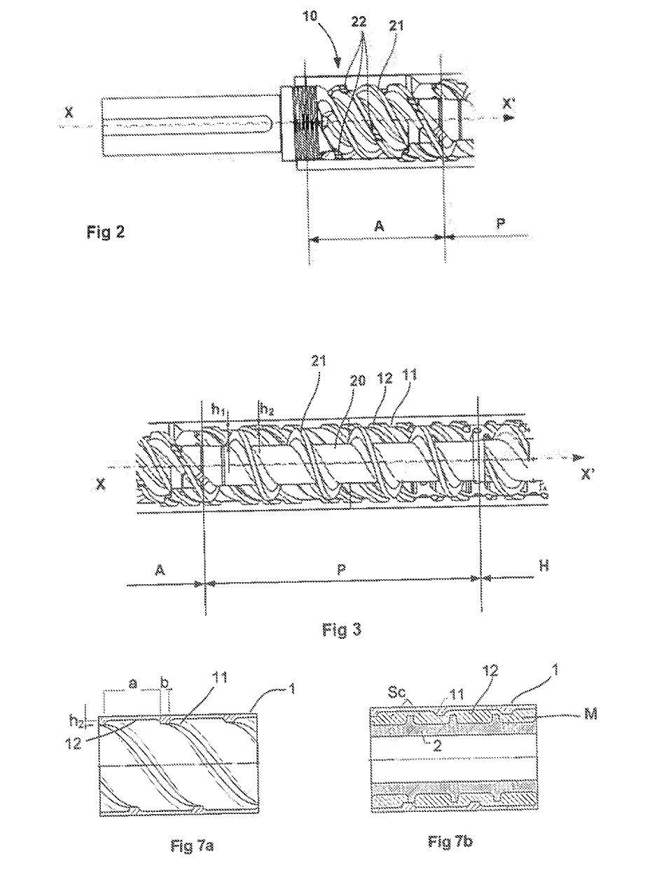

FIG. 2 is a more detailed view of the feed zone A situated upstream of the extruder and into which the material is introduced via an orifice 10. At the feed zone, the screw comprises a high number of flights, the pitch of which is comprised between one and two times the diameter D of the screw.

Good results have been obtained with a screw comprising at least four flights.

The screw flights situated in this feed zone A are equipped with cutouts 22 intended to encourage the catching of and to propel the incoming material. The most significant results have been obtained when each flight comprises at least one cutout arranged in such a way that no cutout is axially aligned with a cutout arranged on the adjacent flights.

The height h₂ of the flight of the barrel and the height h₁ of the flight of the screw are constant over the length of the feed zone so as to allow the mixture to advance in the solid state between the flights of the screw and of the barrel.

According to one advantageous feature of the invention, the width “a” of the grooves or free spaces of the helicoidal path 12 is greater than the width “b” of the helicoidal flight 11 of the barrel 1. This condition is met over the entire length of the barrel 1.

In what follows an explanation will be given of how the material behaves in relation to the feed zone A where the mixture is highly viscous and the passage of the mixture is likened to that of a solid slipping along the flights of the screw 2 and those of the barrel 1 and having an effect of pushing on the mixture downstream. FIG. 7a illustrates the geometry of the barrel 1. according to the invention. FIG. 7b illustrates the mixture M as it is formed inside the extruder. The flow of mixture passes both between the flights of the screw 2 and those of the barrel 1 with shear stress being applied on the shearing surfaces Sc. As the screw 2 is rotationally driven, the shearing at the surfaces Sc (the surfaces situated at the crests of the flights of the screw and of the barrel) mobilises the mixture M and causes it to advance, whereas friction in the mixture occurs at the same time at the flights of the screw 2 and of the barrel 1, which friction has the tendency to slow it down. The geometry of the barrel 1 has been designed to take account of these two phenomena which have opposing actions on the mixture so as to allow the mixture to be formed correctly and, at the same time, so as to allow the extruder throughput to be increased.

FIG. 3 depicts the compression zone P, in which the pressure and the temperature of the material increase. This increase in pressure will serve to compensate for the pressure drops caused by the circulation of the material through the stages positioned downstream. To achieve that, it is appropriate to reduce the pitch of the screw, which is then between 0.5 and 1.5 times the diameter D of the screw. The increase in pressure will govern the overall throughput of the extruder. So, in order not to reduce the throughput in this zone, it is proposed that the diameter of the shaft be reduced and the height h₁ of the flights of the screw be increased accordingly.

In the compression zone P, the width “a” of the grooves of the helicoidal path 12 is also greater than the width “b” of the helicoidal flight 11 of the barrel 1. Like in the feed zone, the displacement of the elastomeric mixture is rendered possible by the increase in the cross section for passage between the flights of the screw and of the barrel. The material passes through the compression zone undergoing a great deal of shear, which causes an increase in the pressure inside the extruder and contributes to maintaining the extruder throughput despite the pressure drops downstream (in the vault or the die at the exit from the extruder).

In this zone P the screw preferably has just one flight.

The increase in temperature is associated both with the shearing of the material between the flights of the screw and the flights of the barrel and with the slippage of the material on the flights of the screw or of the barrel. As this second effect is reduced, as was indicated hereinabove, in the case of the extruder that forms the subject matter of the invention, it is necessary to provide a zone more particularly devoted to this function.

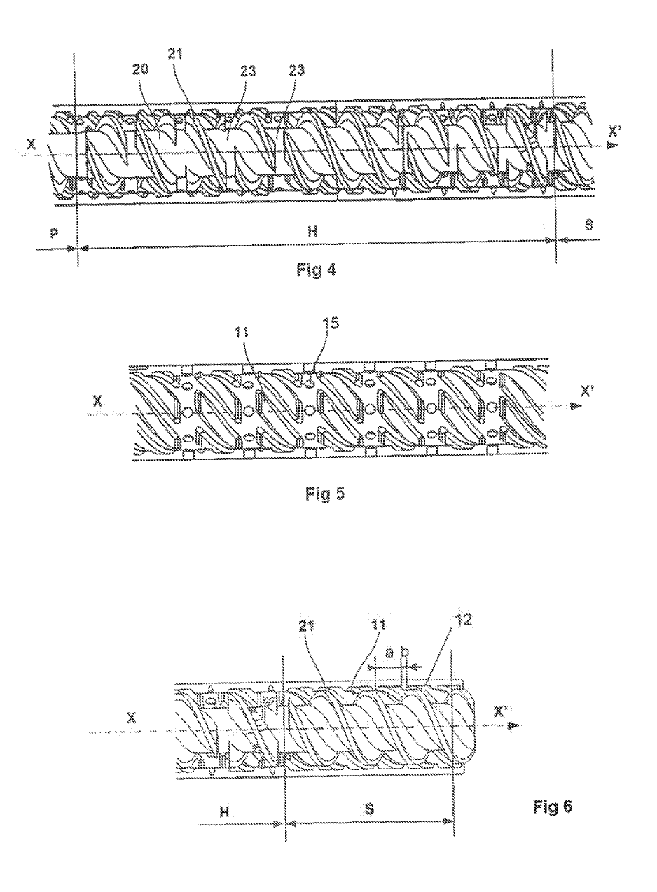

It is in the homogenisation zone H, with reference to FIGS. 4 and 5, that most of the mechanical work converted into thermal form by the material will therefore be done. It is also here that the rheological properties such as the temperature, the fluidity and homogeneity of the distribution of these two characteristics are obtained.

In this zone, the pitch of the screw is reduced to a pitch comprised between 1 and 2 times the diameter D of the screw. The width of the grooves of the helicoidal path is greater than the width of the helicoidal flight of the barrel, making it possible, by increasing the cross section for passage in this zone, to mobilise the mixture and cause it to advance while at the same time ensuring that it has a good shear rate by friction against the flights of the screw and of the barrel.

In order to improve the homogeneity of the material the flow passing through this zone will be encouraged to subdivide further by increasing the number of flights of the screw and of the barrel. In order to encourage this mixing, a first solution is therefore to create free annular spaces 23 by interrupting the flights of the screw or the flights of the barrel over short axial distances in order to redirect the flows.

With reference to FIGS. 5 and 6, it is also possible to increase the work input by creating obstacles, here taking the form of fixed fingers 15 borne by the barrel, and extending radially inwards into the said free annular spaces 23 created at the flights of the screw. In the same way, it is also possible to have the screw bear the fingers and to create the said corresponding annular spaces by axially interrupting the flights of the barrel.

In order for the material to achieve the expected optimal properties, the homogenisation zone H extends axially, as a general rule, over a length that represents at least one third of the total length of the extruder.

The stabilisation zone S situated downstream of the extrusion device makes it possible to adjust the flow rate and pressure of the flow of material before this material is introduced into the extrusion die (not depicted) to give a definitive shape to the profiled strip that is intended to be used in a later conversion device.

In this zone, the pitch of the screw is also comprised between one and two times the diameter D of the screw.

It has been established that optimal conditions for operation of the extruder are achieved for a geometry of the barrel 1 whereby the values of the ratio are comprised between 3 and 10, and preferably between 5 and 10, and for a value of the ratio between the width “a” of the moves of the helicoidal path and the height h₂ of the thread of the barrel 1 greater than 3.

The extruder according to the invention therefore comprises functional zones which are configured according to the information described hereinabove, arranged in the proposed order, and which act in combination with one another. The invention can be adapted in numerous ways in which the axial length of one zone in relation to another can be varied, or alternatively in which the number, height, pitch of the flights in each of the zones can be varied.

In one exemplary embodiment of the invention, with an extruder comprising a screw 2 with a diameter of 150 mm, a pitch height h₁ of 30 mm and rotating in a threaded barrel 1 having three flights 11 of which the flight height h₂ is equal to 10 mm, the pitch is equal to 450 mm, a throughput passing along the flights of the barrel 11 equal to 30% of the total throughput of material passing through the extruder was achieved.

The invention embodiments used as a basis for the present description are therefore nonlimiting, so long as they make it possible to achieve the technical effects as described and claimed.

1. An extruder for shaping a flow of viscoelastic material, comprising:
several zones (A, P, H, S), each of the several zones assigned to a particular rheological function and arranged axially from an upstream end to a downstream end of the extruder and comprising an endless cylindrical screw (2) of given diameter (D), wherein in each of the several zones, there is at least one helicoidal flight extending radially from a central shaft of the endless screw over a height (h₁), in a direction and with a pitch which are defined for each of the several zones, and which is rotationally driven about an axis (XX′) in a barrel,
wherein the barrel comprises at least one helicoidal flight defining at least one helicoidal path that allows flow of the viscoelastic material, and and the viscoelastic material further travels through each of the said zones extending radially inwards over a height (h₂) of the flight of the barrel which is comprised between 0.1 and 0.5 times the height (h₁) of the flight of the screw and in which extruder the flight of the barrel forms a helix rotating in the opposite direction to the direction of the helix formed by the flight of the screw.

2. The extruder according to claim 1, wherein the width (a) of the grooves of the helicoidal path is greater than the width (b) of the helicoidal flight of the barrel (1).

3. The extruder according to claim 1, wherein the ratio between the width (a) of the grooves of the helicoidal path and that (b) of the helicoidal flight of the barrel is comprised between 3 and 10.

4. The extruder according to claim 1, wherein each of the zones, the pitch of the flight of the barrel is greater than or equal to the pitch of the flight of the screw.

5. The extruder according to claim 1, wherein one or more zones of the several zones each separately are provided to perform one of the following rheological functions:
a feed zone (A) devoted to the introduction and plasticising of the material,
a compression zone (P), devoted to increasing the temperature and pressure of the material,
a homogenisation zone (H), devoted to homogenising the rheological properties of the material,
a stabilisation zone (S), devoted to stabilising the flow of material before it leaves through an extrusion die.

6. The extruder according to claim 5, wherein in the feed zone (A), each flight of the screw comprises at least one cutout, the cutout being provided for mechanical catching on the incoming material, and arranged in such a way that no cutout is axially aligned with a cutout located on the adjacent flights.

7. The extruder according to claim 5, wherein in the feed zone (A), the screw comprises at least four flights.

8. The extruder according to claim 5, wherein in the compression zone (P), the screw comprises a single flight.

9. The extruder according to claim 8, wherein in the compression zone (P), the screw has a pitch comprised between 0.5 and 1.5 times the diameter (D) of the screw.

10. The extruder according to claim 9, wherein in the compression zone (P), the diameter of the shaft (20) of the screw is less than the diameter of the shaft of the screw in the zone situated upstream or downstream of the said compression zone (P).

11. The extruder according to claim 5, wherein in the homogenisation zone (H), the screw comprises at least two flights.

12. The extruder according to claim 11, wherein in the homogenisation zone (H), the screw has a pitch comprised between 1 and 1.5 times the diameter (D) of the screw.

13. The extruder according to claim 11, wherein in the homogenisation zone (H), the flights of the screw or of the barrel are interrupted in such a way as to form cylindrical annular spaces.

14. The extruder according to claim 13, wherein the homogenisation zone (H), the shaft of the screw or the barrel comprises fingers extending radially and arranged in such a way as to run in the said cylindrical annular spaces.

15. The extruder according to claim 5, wherein the stabilisation zone (S), the screw and the barrel each comprise two flights.
